(19) United States
(12) Patent Application Publication
(10) Pub. No.: US 2024/0316973 A1
(43) Pub. Date: Sep. 26, 2024

(54) DYNAMIC SHIFTING IMAGES FOR SECURITY PRINTING APPLICATIONS

(71) Applicant: TROY GROUP, INC., Costa Mesa, CA (US)

(72) Inventors: Francis Goossens, Bogota (CO); Xiaorong Cai, Mount Pleasant, SC (US); Michael R. Riley, Steubenville, OH (US); Kevin L. Heilman, Wheeling, WV (US)

(21) Appl. No.: 18/578,088

(22) PCT Filed: Jul. 12, 2022
(86) PCT No.: PCT/US2022/036819

§ 371 Date: Jan. 10, 2024

Related U.S. Application Data
(60) Provisional application No. 63/221,353, filed on Jul. 13, 2021.

(51) Int. Cl. B41M 3/14; G06F 21/36

(52) U.S. Cl. CPC B41M 3/148; G06F 21/36; G06F 2221/2103

(57) ABSTRACT

Security features that may hold multiple levels or classes of security features in one element. The security features may include a Level 1 feature in combination with a Level 4 feature. The Level 1 feature may be identified using human sense. The Level feature may comprise digital security. Unique codes may be provided for security verification of articles.

### CROSS REFERENCE TO RELATED APPLICATIONS

The present application claims priority to U.S. Provisional Patent Application No. 63/221,353, filed Jul. 13, 2021, the entire contents of which are incorporated by reference herein.

### BACKGROUND OF THE INVENTION

With a constant increasing fraud problem both in documents as well as in products, there is a constant need for innovation in security features. To be effective, security must be applied in a layered manner and with functions towards the different users of the document or product (manufacturer, distributor, end user, official control entities, etc.).

As a general standard, different levels or classes of security features can be distinguished: a) Overt security features, or Level 1 features can be identified using the human sense (without the need of any additional tool—mainly vision and/or tact); b) Covert security features, or Level 2 features can be identified with the help of readily available tools such as ultraviolet (UV) lights or magnifying lenses; c) Forensic security features, or Level 3 features, can only be identified using microscopes or other specialized equipment. Additional to this, the use of digital elements like barcodes or other machine-readable marks have been named as Level 4 features or digital security features.

Previously, each of these different level security features have been used in a separate way (optical changing ink as Level 1 feature, invisible UV reactive ink as a Level 2 feature, etc.). The previous also applies to digital security features. As such, combinations of different level security features may be desirable.

### SUMMARY OF THE INVENTION

Examples disclosed herein may be directed to security features that may hold multiple levels or classes of security features in one element. The security features may include a Level 1 feature in combination with a Level 4 feature. In examples, other levels (e.g., Level 2 feature, Level 3 feature, etc.) may be included with the security feature. For example, there are numerous variations of linear barcodes and/or 2D barcodes that besides a product/unit identification function also have a specific security function (Level 4 feature). Some of these barcodes have been printed in ink/toner that contains a Level 2 or Level 3 feature (UV reactive or taggant reactive materials). Such codes however, do not include a Level 1 feature. Examples herein accordingly may include a Level 1 feature in combination with a Level 4 feature. In examples, the Level 1 feature (can be identified using human sense) may have an advantage to allow an end user to authenticate a product without the use of any additional element.

In examples, the Level 1 feature may comprise an image element having a first image when the image element is viewed at a first angle and having a second image when the image element is viewed at a second angle.

Examples disclosed herein may include a security feature having Level 4 features of digital security, which may allow the security feature to comprise a code that, contrary to conventional technologies, is printed as a unique code.

Examples disclosed herein may be directed to light conductive/reflective technology applied with digital technology. Examples disclosed herein may be used with a variety of articles, including documents and products, which may include but are not limited to labels, packaging, or other articles, which may increase the variety of uses of the examples and the application of the security features.

Features disclosed herein may include one or more of the following, but are not limited to:

A system for the generation of a security feature to be printed that will have various levels of security included in the same element.

Variable data elements that may consist mainly but not exclusively of alphanumerical elements and/or other symbols.

Multiple variable data elements that may allow the combination of data elements to create unique codes.

Security features printed with, mainly but not exclusively, ink with a reflective aspect allowing for more than one data element to be read according to a viewing angle.

Variable data elements that may be mainly, but not exclusively, made up of line structures.

Variable data elements that in each view hold patterns or arrays generated in such a way that a pattern or array generates a first image that differs from a second image in the same structure but depending on the angle of view.

A security feature may hold at least two images due to the use of different angles in the patterns but can hold more images depending on the patterns or angles used.

Variable data elements printed with, mainly but not exclusively, ink with reflective aspects allowing, at least, a first image to be seen when viewed under a first angle and a second image when viewed under a different angle.

Variable data elements that under a reflection of normal light read the different images by a set of cameras and feed the data into a database for identification or control of the article on which the variable data elements have been applied.

Variable data elements that under the reflection of normal light are read by a camera of a smart phone and connect to a software program (application or “app”) to feed the data back into a database.

Variable data elements that under the reflection of normal light are read by the human eye and are entered into a software program (application or “app”) to feed the data back into a database.

Variable data elements that under ultraviolet (UV) light are identified as authentic.

### BRIEF DESCRIPTION OF THE FIGURES

FIG. 1A illustrates a security feature.

FIG. 1B illustrates the security feature of FIG. 1A viewed at a different angle.

FIG. 1C illustrates a viewing angle of the security feature of FIG. 1A.

FIG. 2A illustrates a cross sectional view of the security feature of FIG. 1A along line A-A.

FIG. 2B illustrates a cross sectional view of the security feature of FIG. 1A along line B-B.

FIG. 2C illustrates a cross sectional view of the security feature of FIG. 1A along line C-C.

FIG. 3 illustrates a schematic view of a system.

FIG. 4 illustrates a schematic view of a printing device for printing upon articles.

FIG. 5 illustrates a view of a camera system for visualizing a security feature at varied angles.

FIG. 6 illustrates a schematic view of a system.

FIG. 7 illustrates a schematic view of a system identifying data elements of a security feature.

FIG. 8 illustrates a schematic view of the system identifying additional data elements of the security feature shown in FIG. 7.

FIG. 9 illustrates a schematic view of the system providing a security verification.

FIG. 10 illustrates a schematic view of a user visualizing a security feature at a first angle.

FIG. 11 illustrates a schematic view of a user visualizing the security feature of FIG. 10 at a second angle.

FIG. 12 illustrates a schematic view of a system providing a security verification.

### DETAILED DESCRIPTION

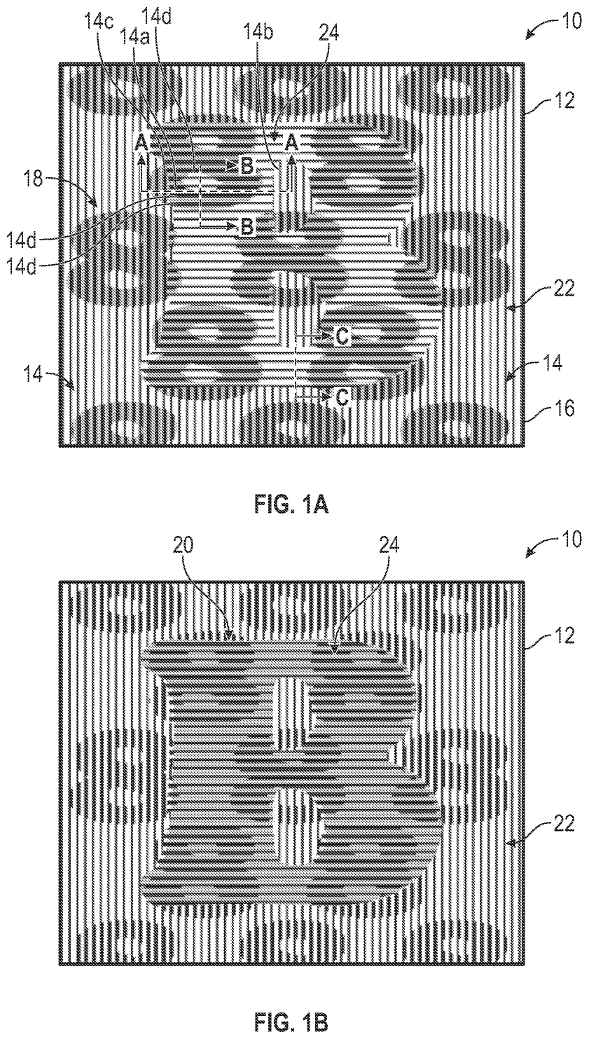

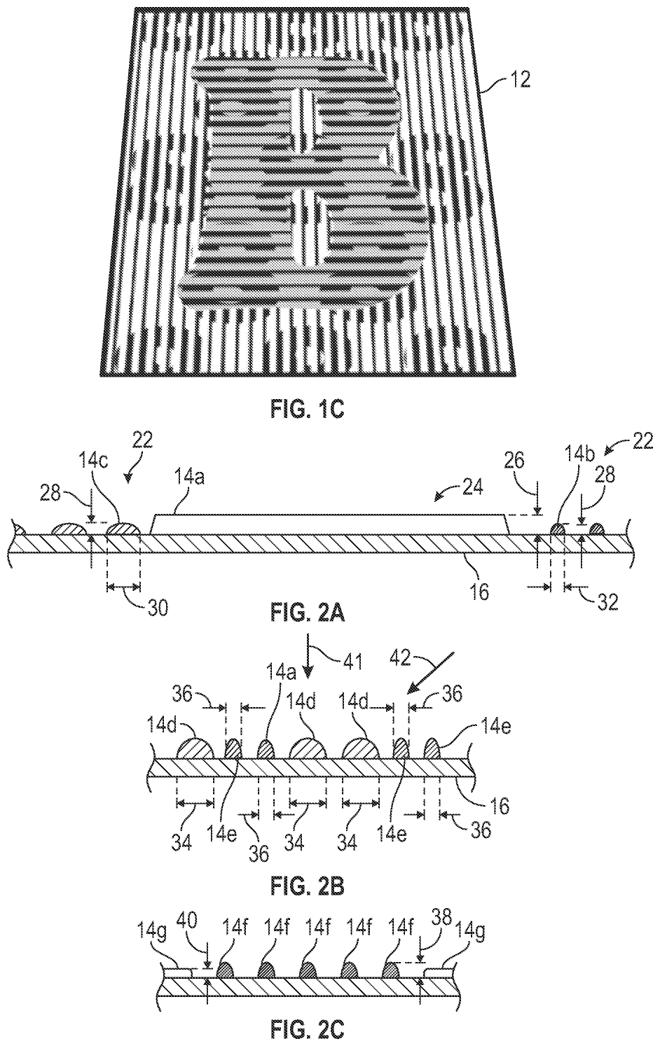

FIG. 1A illustrates an example of a security feature 10 that may be utilized in examples herein. The security feature 10 may have other forms in other examples herein. The security feature 10 may include an image element 12 that may have a first image (represented in FIG. 1A) when the image element 12 is viewed at a first angle and having a second image (represented in FIG. 1B) when the image element 12 is viewed at a second angle.

The variation in the images (e.g., first image and second image) due to viewing angle may be produced in a variety of manners. In examples, different reflective or conductive aspects of light under different angles may be utilized. Such an effect may be obtained, although not exclusively, with high reflective ink or varnishes as well as with other reflective materials such as metallic foils, inks, and toners. In examples, the first image may be visible or revealed when viewed at an angle near vertical or normal to the surface of the image element 12, and the second image may be visible or revealed when viewed at a different angle. The different angle may comprise an angle closer to a horizontal plane (e.g., between the axis normal to the surface of the image element 12 and the plane of the image element 12). FIG. 1C, for example, illustrates a view of the image element 12 at such an angle. In examples, other angles may make visible or reveal the first image and the second image as desired.

In examples, the second image may comprise a latent image when the first image is visible or revealed at the first angle. Further, the first image may comprise a latent image when the second image is visible or revealed at the second angle. As such, a user may vary the viewing angle of the image element 12 to reveal the first image and the second image sequentially. In examples, more than two images may be included in the image element 12 as the use of different configurations of the image element 12 may produce multiple latent images at different viewing angles (e.g., at more than two viewing angles).

In examples, the image element 12 may be configured to have a first image when the image element 12 is viewed at a first angle and may have a second image when the image element 12 is viewed at a second angle by use of a plurality of raised features 14 of the image element 12. The plurality of raised features 14, for example, may be configured to produce different images at different viewing angles.

Referring to FIG. 1A, for example, the plurality of raised features 14 may be arranged in an array upon a substrate 16 (e.g., the underlying surface that the plurality of raised features 14 are provided upon). A first portion 18 of the plurality of raised features 14 may form the first image (e.g., the pattern of numerals “8” appearing in FIG. 1A). Referring to FIG. 1B, a second portion 20 of the plurality of raised features 14 may form the second image (e.g., the letter “B” appearing in FIG. 1B). The portions 18, 20 of the plurality of raised features 14 may be interspersed with each other or otherwise combined in the array upon the substrate 16.

The first portion 18 of the plurality of raised features 14 may differ from the second portion 20 in configuration to produce the different images at different viewing angles. For example, the first portion 18 of the plurality of raised features 14 may differ from the second portion 20 in one or more of a height, thickness, or angle of the plurality of raised features 14 of the first portion 18, among other features of the plurality of raised features 14.

The plurality of raised features 14, for example, may comprise a plurality of line structures that may extend parallel with each other. One or more sets of line structures may extend in a direction parallel with each other. For example, a first set 22 of the line structures may extend in a first direction vertically in the page as shown in FIG. 1A. A second set 24 of the line structures may extend in a second direction that is at a different angle than the first direction. For example, the second direction may be horizontal in the page as shown in FIG. 1A and may be perpendicular to the first direction. The second set 24 may form the letter “B” as shown in FIG. 1B. In examples, other angles may be utilized to differentiate between the first set 22 and the second set 24 or other sets of the line structures.

In examples, the thickness of the raised features 14 or line structures may differ to produce different images visible or revealed at different angles. For example, referring to FIG. 1A, the raised features 14 forming the numerals “8” in the first image may be thicker than the raised features 14 forming the remainder of the image element 12. Such a feature may allow the numerals “8” to be visible or revealed when viewed at the first angle (e.g., at an angle near vertical or normal to the surface of the image element 12).

In examples, a height of the raised features 14 or line structures may differ to produce different images visible or revealed at different angles. For example, referring to FIG. 1B, the height of the raised features 14 or line structures forming the letter “B” may have a greater height than the raised features 14 or line structures forming remainder of the image element 12. Such a feature is represented in FIG. 2A, which is taken along line A-A in FIG. 1A.

FIG. 2A illustrates that the raised feature 14a may comprise a line structure that extends horizontally as shown in FIG. 1A. The raised feature 14a may comprise a portion of the second set 24 of raised features 14 that may extend horizontally. The raised feature 14a may have a height 26 from the substrate 16 that is greater than the height 28 of adjacent raised features 14b, 14c that may comprise a portion of the remainder of the image element 12. Further, as shown in FIG. 2A, the adjacent raised features 14b, 14c, may extend at a different angle (e.g., perpendicular) with respect to the raised feature 14a. The adjacent raised features 14b, 14c may extend vertically as part of the first set 22 of raised features 14. As shown in FIG. 2A, the adjacent raised feature 14c forming the numeral “8” shown in FIG. 1A may have a greater thickness 30 than the thickness 32 of the adjacent raised feature 14b that comprises a portion of the remainder of the image element 12.

FIG. 2B is taken along line B-B in FIG. 1A, at a view perpendicular to the view shown in FIG. 2A. The raised features 14d forming the numeral “8” in FIG. 1A are shown to have a greater thickness 34 than the thickness 36 of the raised features 14a, 14e that comprise a portion of the remainder of the image element 12.

FIG. 2C is taken along line C-C in FIG. 1A. Each of the raised features 14f forming the letter “B” in FIG. 1B have a greater height 38 than the height 40 of the raised features 14g comprising a portion of the remainder of the image element 12. The raised features 14f are shown to extend at a different angle (e.g., perpendicular) with respect to the raised features 14g forming the remainder of the image element 12.

In the example of FIGS. 1A-2C, the increased thickness of the raised features 14 may produce the first image comprising the repeating pattern of numerals “8.” For example, referring to FIG. 1A, the pattern of numerals “8” is visible at an angle comprising a vertical angle or angle normal to the surface of the image element 12 (as marked with a line 41 in FIG. 2B). The second image or the letter “B” shown in FIG. 1B may comprise a latent image in the view represented in FIG. 1A.

The difference in angle of the raised features 14 forming the second image or letter “B” shown in FIG. 1B, and/or the difference in height of the raised features forming the second image or letter “B” may allow the second image to be revealed at a different angle than shown in FIG. 1A. For example, FIG. 1B represents a view of the image element 12 at a different angle than shown in FIG. 1A. The angle may comprise an angle closer to horizontal (as represented in FIG. 1C for example, and with the line 42 marked in FIG. 2B). The angle may be in a plane that is parallel with the direction of the second set 24 of line structures (as represented in view of FIG. 1C). The angle may allow the horizontal extent of the second set 24 of line structures to be more prominent, and may allow the increased height of the second set 24 (due to the reduced viewing angle) to be more prominent. Further, the thickness of the raised features forming the first image of the repeating pattern of numerals “8” may have reduced prominence due to the increased prominence of the raised features forming the second image or letter “B.” As such, referring to FIG. 1B, the difference in viewing angle may allow the second image or latent image to appear and comprise the letter “B” shown in FIG. 1B.

In examples, other differences between the raised features 14 may allow the image element 12 to have a first image when the image element 12 is viewed at a first angle and have a second image when the image element 12 is viewed at a second angle. In examples, the raised features 14 may each extend in a same direction (e.g., all parallel with each other) or may lack a direction (e.g., a series of dots). A height difference of the raised features solely may allow the image element to have a first image when the image element 12 is viewed at a first angle and have a second image when the image element 12 is viewed at a second angle. For example, an increased height of a first portion of the raised features relative to a second portion of raised features may allow the first portion to produce a second image at a lowered or more horizontal viewing angle (such as shown in FIG. 1C). In examples, solely an angle of raised features may differ to allow the image element to have a first image when the image element 12 is viewed at a first angle and have a second image when the image element 12 is viewed at a second angle. In examples, solely a thickness of raised features may differ to allow the image element to have a first image when the image element 12 is viewed at a first angle and have a second image when the image element 12 is viewed at a second angle. FIGS. 1A-2C represents a combination of such features used to produce different images at different viewing angles, yet one feature or any combination of features may be utilized to produce multiple images as desired (e.g., a combination of height and angle, a combination of height and thickness, a combination of angle and thickness, etc.). Other features may be utilized solely or in combination as well (e.g., distance between the raised features, shape of the raised features, etc.). In examples, the raised features may comprise a series of dots (e.g., dot structures) or may have another configuration that differs from the line structures shown in FIGS. 1A-2C.

The raised features 14 may be formed by a printing or production method resulting in raised features. The raised features may be formed by printing processes that may allow the configuration of the raised features to be varied as desired and be varied repeatedly and/or rapidly.

For example, the raised features 14 may be formed with a printing device that may be configured to print varied configurations of raised features in sequence. A toner printer or an ink printer such as an inkjet printer or other form of printing device, for example, may be utilized to produce the raised features and accordingly produce the appearance of the image element 12. The printing device may be configured to vary the height, thickness, or angle of the raised features, among other properties of the raised features, to produce a desired configuration of raised features 14 and image element 12 as desired. The printing device may be configured to sequentially vary the configuration of the raised features 14 and image element 12 for different image elements as desired.

One or more of the first image or the second image may comprise a data element for a code that is unique within a set of a plurality of codes. For example, referring to FIG. 1A, the first image comprises a repeating pattern of the numeral “8.” The numeral “8” may comprise a data element for a code. The data element may comprise an element of data that may be provided to a reader for identification of the code. The data element and code may comprise a form of a Level 4 feature or digital security feature. Other forms of data elements may be utilized in examples. Similarly, the letter “B” shown in the second image (as illustrated in FIG. 1B) may comprise a data element for the code. As such, the code may be the combination of the numeral “8” and the letter “B” in the example shown in FIGS. 1A-2C.

The data elements of the first image or the second image may comprise alphanumerical elements or symbols, or may have other forms as desired. The data elements may comprise data elements that may be identifiable by a human user visually, as a Level 1 security feature. As such, the data elements may be readable by a human user, and thus may comprise an identifiable code such as “8,” “B.” Other identifiable alphanumerical elements or symbols (e.g., !, @, #, %, &), may be similarly utilized.

Each image element may hold two variable data elements, which may be referred to as data pairs. The different data elements included in the data pair may be seen by tilting the image element.

Each data pair (first view+second view) exists of variable data so that unique codes are generated so that every article on which a code (which may be a combination of data pairs) is applied is uniquely identified.

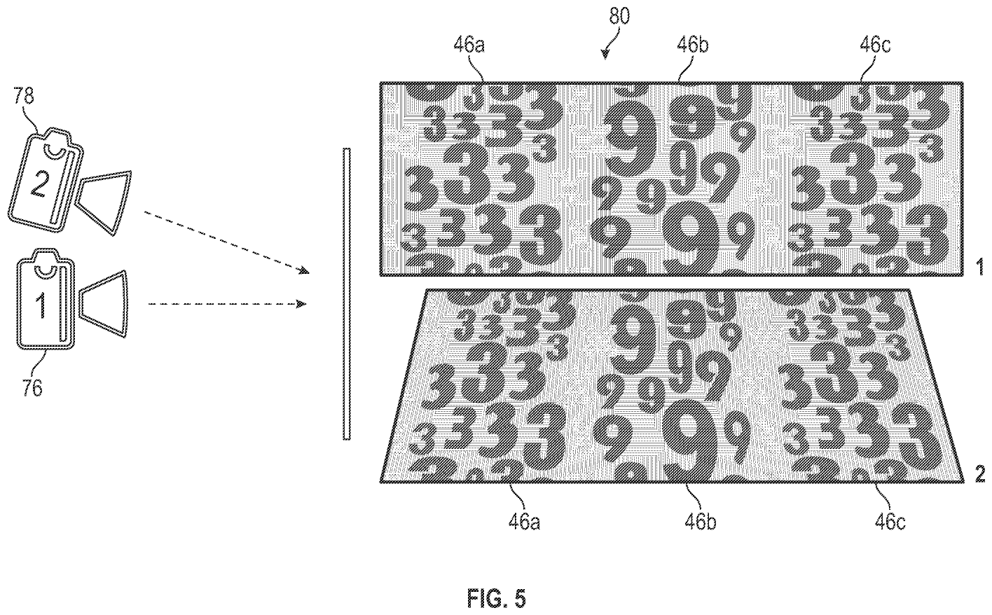

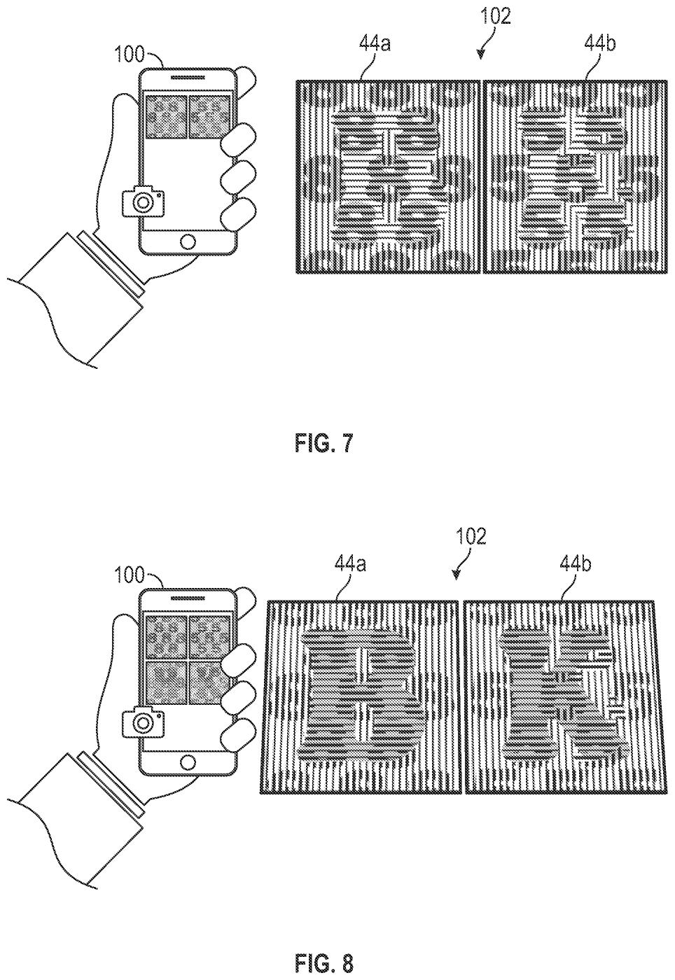

The code may comprise a single data element in examples, or may comprise a plurality of data elements. The code may be produced via a plurality of the image elements utilized in combination. For example, referring to FIGS. 1A and 1B, a single image element 12 may produce a first data element of “8” in the first image (as shown in FIG. 1A) and a second data element of “B” in the second image (as shown in FIG. 1B). The combination of data elements “8” and “B” may comprise the code. In examples, the image element 12 may contain more than two data elements (e.g., three data elements, four data elements), which may comprise the code. In examples, multiple image elements may be utilized to produce multiple data elements, which may comprise the code. For example, referring to FIGS. 7-8, two image elements 44a, b may be positioned adjacent to each other. A first image element 44a may include data elements “8” and “B” and the second image element 44b may include data elements “5” and “K.” The combination of data elements “8,” “B”, “5,” and “K” may comprise the code. Similarly as shown in FIG. 5, three image elements 46a, b, c may produce data elements of “3,” “E,” “9,” “K,” “3,” “E,” which may comprise the code. Various combination of image elements, and various numbers of data elements within each image element may comprise the code.

The code may be utilized for security verification of the article that the security feature (e.g., a security feature 10 as shown in FIGS. 1A-1C) is provided upon. As such, the code may be a unique code within a set of a plurality of codes, for unique identification of the article. The code may be visualized by a human user for a Level 1 security feature identification of the code. The code may also be matched electronically with a corresponding code stored in a database for a Level 4 security feature. The method of producing the security feature may allow each code to be unique within the set of the plurality of codes. For example, printing such as toner printer or ink printing or other forms of printing allowing for sequential variation of the code may be utilized.

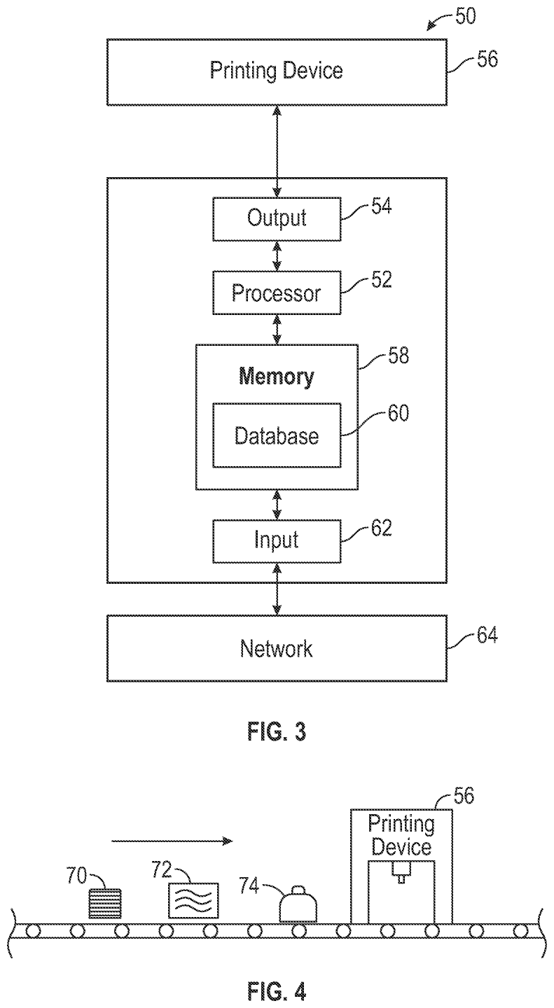

FIG. 3 illustrates an exemplary system 50 that may be utilized for producing a security feature for an article. The system 50 may include a processor 52 that may be configured or programmed to perform the processes disclosed herein. The processor 52 may be configured or programmed to produce the configuration of the security feature (e.g., a security feature 10 as shown in FIGS. 1A-1C), and may produce the appearance of the one or more image elements comprising the security feature. The processor 52 may comprise a microprocessor, CPU, or other form of processor for performing the processes disclosed herein.

The processor 52 may be operatively coupled to an output 54 that may be configured to communicate with a printing device 56. The output 54 may comprise a variety of forms of electrical connections, ports, or wireless connections, among other forms of output for communication with the printing device 56. In examples, any of the components disclosed herein may be integrated into the printing device 56 or may be positioned remote as desired.

The system 50 may include a memory 58. The memory 58 may comprise electronic memory such as RAM or ROM, a hard drive (which may be solid state or mechanical) or may comprise another form of memory 58. The memory 58 may be located with the processor 52 or may be remote (e.g., wireless or cloud computing) as desired. The memory 58 may store data for the processor 52 to operate upon. In examples, the memory 58 may include a database 60 of a set of the codes. The database 60 may be prepopulated with the set of codes, or the database 60 may be populated with the codes comprising the set of codes by the processor 52. For example, the processor 52, in examples, may be configured to generate the codes and store the generated codes in the database 60 to form the set of codes or add to the set of codes.

The database 60 may be utilized to store the set of codes for matching with a code of a security feature (e.g., a security feature 10 as shown in FIGS. 1A-1C) provided upon an article. As such, a code produced by the printing device 56 may be later matched with a corresponding code in the database 60 during a security verification of the article. The database 60 accordingly may comprise a repository of the codes comprising the set of codes that may be utilized for later security verification of the article.

Each code within the set of codes may be unique. As such, each code may be different from the other codes within the set for unique security verification of the article within the set of codes. The set of codes may encompass all codes produced for a particular article or type of article, or may comprise all codes produced for any security feature that is produced. As such, a unique identifier for the article may be provided for the code, which may be verified electronically (as a Level 4 security feature). The set of the plurality of codes may be stored within the database.

The system 50 may include an input 62 that may be configured to provide input into the system 50. The input 62 may comprise electrical connections, ports, or wireless connections, among other forms of input for the system. The input 62 may comprise an input device such as a keyboard, tablet, touchscreen, mouse, or other form of input for the system 50. The input 62 may be utilized for control of the system 50 and/or operation of the production of the security features with the printing device 56. In examples, the input 62 may be utilized to match a code of a security feature that is on an article with a corresponding code contained in the database 60 for a security verification.

In examples, the system 50 may communicate via a network 64 for communication with other devices. Such other devices may include, but are not limited to other input devices configured to receive an identification of a data element of a code of a security feature. Such other input devices may be utilized to identify and match the code with a corresponding code contained in the database 60. In examples, the network 64 may comprise an internet connection, mobile device connection, local area network connection, or other form of connection for communicating with other devices (which may comprise input devices).

The printing device 56 may comprise a device for producing the security feature (e.g., a security feature 10 as shown in FIGS. 1A-IC). The printing device 56 may be configured to sequentially vary the configuration of the raised features and image element for different image elements as desired. The printing device 56 accordingly may comprise a toner printer or an ink printer (e.g., inkjet printer) or other form of printer as desired. The printing device 56 may be configured to receive instructions from the processor 52 of the configuration of the image element for different image elements and security features as desired. The printing device 56 may print the security feature and the image element of the security feature.

The printing device 56 may be configured to produce one or more image elements (such as the image element 12 shown in FIGS. 1A-IC) upon a substrate 16. The substrate may comprise a backing layer for the security feature for affixation to an article (e.g., an adhesive layer or other form of layer for affixation), or may comprise a surface of the article itself. For example, referring to FIG. 4, the printing device 56 may be configured to produce the security feature 70 solely. The security feature 70 may be affixed or otherwise placed upon an article for security verification of that article.

In examples, the printing device 56 may print a security feature upon an article. The article may comprise a document 72 or a product 74 or any other form of article for security verification. For example, the article may comprise a financial document, a form of currency, labels, packaging, tickets, a certificate, electronic devices, household goods, medical or pharmaceutical products, or any other form of article for security verification. A document 72 in the form of a certificate is shown in FIG. 4, and a product 74 in the form of a pharmaceutical bottle is shown in FIG. 4, although the scope of articles is not limited to such articles. The security feature may be produced in a location for access by a user (e.g., for the Level 1 security verification and the Level 4 security verification).

In exemplary methods of operation, the processor 52 may instruct the printing device 56 to produce a security feature. The processor 52 may generate the code of the security feature and the configuration of the image element (e.g., a configuration of raised features). The processor 52 may be programmed generate the code by itself or may generate the code based on retrieval from the database 60 or based on input from a user through the input 62. The printing device 56 may produce the security feature in a desired manner by itself or upon an article.

The data pair may be generated as a special font, a library of high-resolution images or through an application that generates line patterns/structures in which the angles, line width and distance are defined or a combination of techniques may be utilized to generate both data elements of a data pair as a dynamic element.

In examples, the image element produced by the printing device 56 may be a first image element, and a method may include providing a second image element (as represented in FIG. 7 for example). The second image element (e.g., image element 44b shown in FIG. 7) may be provided adjacent to the first image element (e.g., image element 44a shown in FIG. 7). One or more of a first image or a second image of the first image element 44a may comprise a first data element for the code, and one or more of a first image or a second image of the second image element 44b may comprise a second data element for the code. For example, as shown in FIG. 7, the first data element may be “8” and the second data element may be “5.” Further, the first image element 44a may include a third data element “B” as shown in FIG. 8, and the second image element 44b may include a fourth data element “K” as shown in FIG. 8. As such, the code may comprise “8,” “B”, “5,” and “K.” In examples, a greater number of image elements may be provided for the security feature. For example, FIG. 5 illustrates three image elements utilized.

Under the different viewing angles, the view contains different variable data that may consist of alphanumerical elements and/or other symbols so that a multitude of combinations may be created, thus allowing a unique identification of each article on which the codes are applied.

In examples, the printing device 56 may produce unique codes and security features sequentially. For example, a first security feature may be provided for a first article (e.g., article 74 as shown in FIG. 4), and the printing device 56 may produce a second security feature for a second article (e.g., article 72 as shown in FIG. 4). One or more of a first image or a second image of the second security feature (the image element of the second security feature) may comprise a second data element for a second code that is unique within the set of the plurality of codes. For example, the code of the first security feature for the first article 74 may be different than the code of the second security feature for the second article 72. Each code may be stored in the database 60 as a unique security identifier for the respective articles 74, 72. The first code may uniquely identify the first article and the second code may uniquely identify the second article. Additional codes may uniquely identify additional articles (e.g., a third code for a third article, a fourth code for a fourth article, etc.).

In examples, the processor 52 may populate the database 60 with the codes after the respective code has been produced for the article, or the database 60 may be prepopulated with the codes. In examples, a user may manually input the codes, which may be stored in the database 60.

Other systems, apparatuses, and methods may be utilized as desired. Features of systems, apparatuses, and methods may be varied, combined or substituted as desired.

The security feature may be provided upon the article and may be placed in circulation in trade or commerce or otherwise utilized in a manner in which security verification of the article may be desired. The security verification may occur at a time of production of the article in examples. At a desired time for security verification, the security feature may be utilized for security verification of the article.

In exemplary methods herein, a data element for a code on a security feature for an article may be identified. For example, referring to FIG. 1A, the data element may comprise “8,” of the code (comprising “8” and “B”) for the security feature 10. The article may comprise an article that may be disclosed herein, or another form of article. The identification of the data element may be visual, in accordance with a Level 1 security feature. For example, the data element may be visually identified on the security feature by a human user. The user may vary the viewing angle of the security feature to view one or more data elements for the code. For example, as seen in FIGS. 1A-1C, a user may tilt the security feature to reveal the second data element of “B” for the unique code comprising “8,” “B.”

In examples, the visual identification of the data elements for the codes may occur utilizing one or more input devices. The one or more input devices may be configured to receive an identification of a data element for the code. For example, referring to FIG. 5, one or more input devices in the form of camera devices 76, 78 may be configured to visually identify the data elements. The camera devices 76, 78 may be fixed in position at different viewing angles to view the image elements 46a, 46b, 46c at different angles to reveal the different data elements contained therein. For example, the first camera device 76 may be positioned to visualize the first image including “3,” “9”, and “9” of the code, and the second camera device 78 may be positioned to visualize a second image including “E,” “K”, “E” of the code. In examples, a configuration as shown in FIG. 5 may be utilized for high speed or production line verification of the security features, although other implementations may be utilized. In examples, the security feature 80 including the image elements 46a, 46b, 46c may be tilted with respect to a single camera device 76, or a single camera device 76 may be tilted with respect to the security feature 80 for identification of the multiple data elements of the security feature 80.

As shown in FIG. 5, the set of cameras may feed data back into a database for identification or control of the article on which the variable data set has been applied.

Upon identification of the one or more data elements comprising the code, the code may be matched with a corresponding code in a database for security verification of the article. For example, the code may be electronically transmitted or otherwise compared with a code stored in a database. In examples, the code may be stored locally in a database with an input device that identifies the code. In examples, the database may be remote such as a database 60 as shown in FIG. 3.

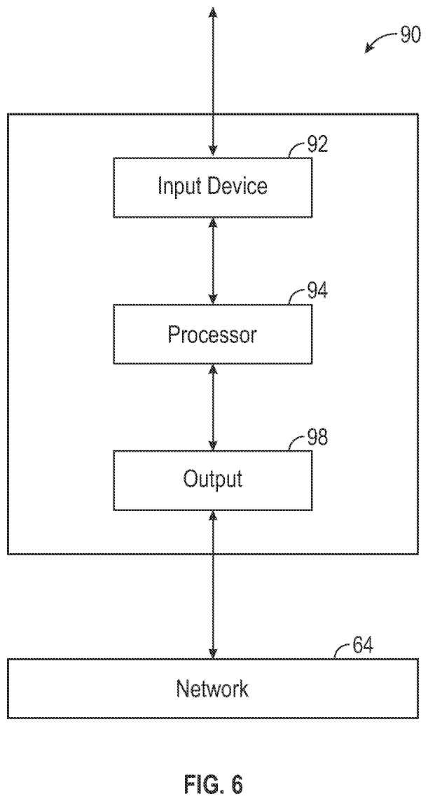

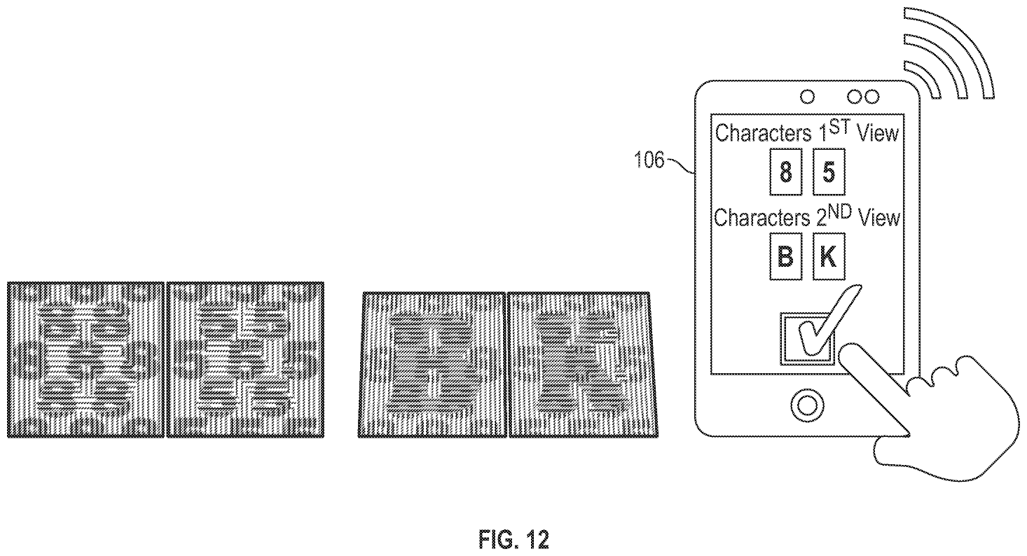

Referring to FIG. 6, for example, a system 90 for verifying a code on a security feature is disclosed. The system may include an input device 92 that may be configured to receive an identification of a data element for the code on the security feature for an article. The input device 92 may have a variety of forms and may comprise one or more camera devices as shown in FIG. 5, or may have other forms such as electronic screens, keyboards, touchscreens (as represented in FIG. 12) or may have other forms as desired. The identification of the data element may be received in a variety of manners (e.g., visually or via data input).

The system 90 may include a processor 94 that may be configured to produce a security verification of the code based on a match of the code with a corresponding code in a database. The processor 94 may comprise a microprocessor, CPU, or other form of processor for performing the processes disclosed herein. The processor 94 may be programmed to perform the processes disclosed herein. The processor 94 may receive the code and may match the code with the corresponding code in the database. The match of the code with the corresponding code in the database may produce the security verification.

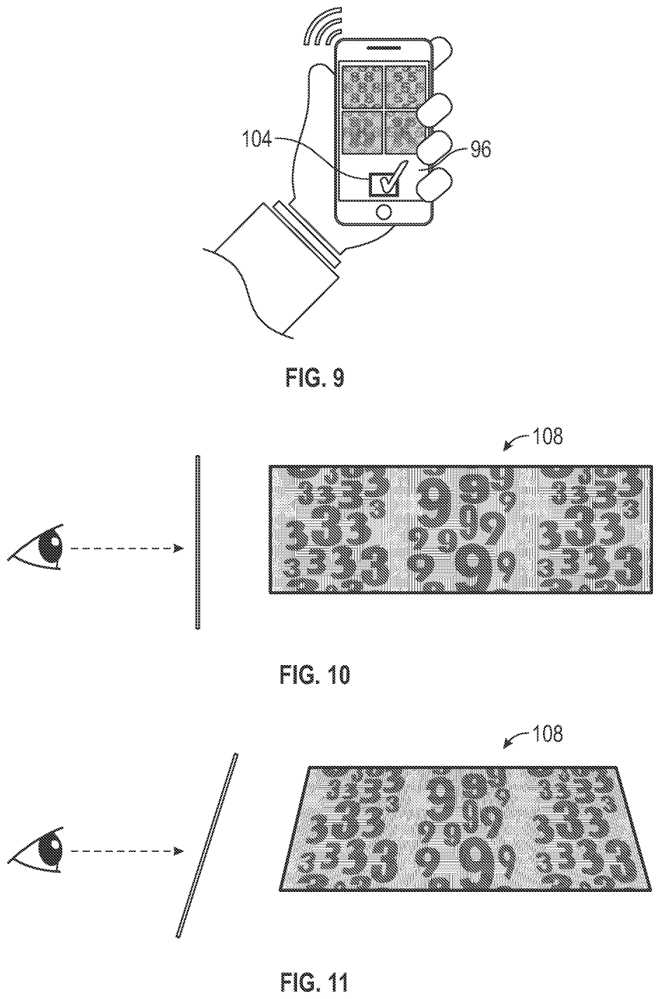

The security verification may be presented to a user or otherwise utilized for security verification of the article (e.g., the security verification of the article may be stored electronically for future reference, among other uses). In an example in which the security verification is presented to a user, the security verification may be provided on a display 96 (as represented in FIG. 9) or otherwise indicated to a user (e.g., via email, text message, lights, sounds, or other forms of notifications or indications). In examples, the security verification may be presented to another party (e.g., a third party), upon such party desiring a security verification (e.g., a verification of a ticket to an event venue, or verification of a financial document for transaction, etc.).

The processor 94 may match the code with a corresponding code in a database via use of an output 98, which may comprise electrical connections, ports, or wireless connections, among other forms of output for the system. The output 98 may be operatively linked to the network 64, which may be utilized to match the code with the corresponding code in remote database 60 as represented in FIG. 3 for example. Upon matching of the code the processor 94 may determine that a security verification occurred and may produce an indication of the security verification to the user (or another party) as desired, or the security verification may be otherwise utilized.

A system 90 as disclosed herein may have a variety of implementations. For example, FIGS. 7-9 illustrate an implementation of a system 90 in which the input device 92 comprises a mobile device 100. The mobile device 100 may comprise an electronic device (e.g., an electronic phone, smart phone, tablet, or laptop, among others) that may be utilized to receive an identification of a data element for the code. For example, a user may image the security feature 102 using the mobile device 100 as shown in FIG. 7. A camera device of the mobile device 100 may be utilized at a first angle with respect to the security feature 102. The data elements of “8” and “5” may be identified.

Referring to FIG. 8, the mobile device 100 may be tilted with respect to the security feature 102 (e.g., either the security feature 102 may be tilted or the mobile device 100 may be tilted) to identify the data elements of “B” and “K” via the camera device of the mobile device 100.

The mobile device 100 may include a software program (an application or “app”) for performing the identification and security identification of the code. Referring to FIG. 9, a processor of the mobile device 100 may produce the security identification of the code based on a match of the code with a corresponding code in a database. For example, the code may be transmitted via an output to a network that may be utilized for matching with a corresponding code in a remote database. In examples, the database may be local to the mobile device 100 and matched by the processor within the mobile device 100.

Producing the security verification may include displaying the security verification 104 on the display 96 of the mobile device 100. Other forms of notifications may be utilized as desired (e.g., via email, text message, lights, sounds, or other forms of notifications).

Other systems may be utilized (e.g., static computers with access to an internet connection, or other forms of computers) in examples.

In examples, other forms of input to the input device may be utilized. For example, FIGS. 10-11, illustrate an example in which the code may be input into the input device (comprising a mobile device) manually. Referring to FIG. 10, a user may view the security feature 108 at a first angle to identify the data elements of “3,” “9”, and “3.” Referring to FIG. 11, the user may view the security feature 108 at a second different angle to identify the data elements of “E,” “K,” “E.” These identified data elements may be manually input into an input device. FIG. 12, for example, illustrates such a manual input into a mobile device 106. Predefined boxes for entry of the data elements and the security verification may be provided in a software program (e.g., application or app) utilized for such purposes. In examples, combinations of camera devices and manual input may be utilized to input the code into an input device.

In examples, other forms of input devices may be utilized. The input device may be utilized in a commercial or production line verification process. Systems dedicated for verification of a security feature may be utilized.

Other systems, apparatuses, and methods may be utilized as desired. Features of systems, apparatuses, and methods may be varied, combined or substituted as desired.

Examples disclosed herein may beneficially allow for a user to visually verify a security feature (a Level 1 feature), and for an electronic or digital security feature (a Level 4 feature). Each code may be unique within a set of a plurality of codes for unique security verification of an article. The physical properties of the reflective aspects of the image elements combined with the dynamic aspect of the data pairs may provide each security feature as a Level 1 security feature as well as a Level 4 security feature.

The technology may be utilized to create a three dimensional pattern that may create a variation in contrast (conduction of light) when viewing the image element under a different angle thus revealing different data elements in each view.

In examples, additional layers of security may be provided. For example, a Level 2 feature may be incorporated. UV reactive ink or other reactive materials may be incorporated with a security feature. For example, the security feature may be printed with UV reactive ink or other reactive materials. The Level 2 feature may be identified with a UV light (black light) or other device as desired. Alternatively or in combination, a Level 3 feature may be incorporated. For example, a taggant may be applied to the security feature or other form of identifying material may be utilized. A taggant reader or other device may be utilized.

Features may be utilized solely or in combination with other features disclosed herein.

While examples of the disclosure have been illustrated and described, it is not intended that these examples illustrate and describe all possible forms of the disclosure. Rather, the words used in the specification are words of description rather than limitation, and it is understood that various changes may be made without departing from the spirit and scope of the examples of the disclosure.

What is claimed is:

1. A method comprising:
producing a security feature for an article, the security feature including an image element having a first image when the image element is viewed at a first angle and having a second image when the image element is viewed at a second angle, one or more of the first image or the second image comprising a data element for a code that is unique within a set of a plurality of codes.

2. The method of claim 1, wherein the set of the plurality of codes is stored within a database.

3. The method of claim 1, wherein producing the security feature includes printing the security feature with a printing device.

4. The method of claim 1, wherein the image element includes a plurality of raised features arranged in an array upon a substrate.

5. The method of claim 4, wherein a first portion of the plurality of raised features forms the first image, and a second portion of the plurality of raised features forms the second image, and the first portion differs from the second portion in one or more of a height, thickness, or angle of the plurality of raised features of the first portion.

6. The method of claim 4, wherein the plurality of raised features include a plurality of structures extending parallel with each other.

7. The method of claim 1, wherein one or more of the first image or the second image includes alphanumerical elements or symbols.

8. The method of claim 1, wherein the image element is a first image element, and the method further comprises providing a second image element adjacent to the first image element, the second image element having a first image when the second image element is viewed at a first angle and having a second image when the second image element is viewed at a second angle, one or more of the first image or the second image of the second image element comprising a second data element for the code.

9. The method of claim 1, further comprising producing a second security feature for a second article, the second security feature including a second image element having a first image when the second image element is viewed at a first angle and having a second image when the second image element is viewed at a second angle, one or more of the first image or the second image of the second image element comprising a second data element for a second code that is unique within the set of the plurality of codes.

10. The method of claim 1, wherein the code is configured to be matched with a corresponding code stored in a database for security verification of the article.

11. A method comprising:
identifying a data element for a code on a security feature for an article, the security feature including an image element having a first image when the image element is viewed at a first angle and having a second image when the image element is viewed at a second angle, one or more of the first image or the second image comprising the data element and the code being unique within a set of a plurality of codes; and
matching the code with a corresponding code in a database for security verification of the article.

12. The method of claim 11, wherein the image element includes a plurality of raised features arranged in an array upon a substrate.

13. The method of claim 12, wherein a first portion of the plurality of raised features forms the first image, and a second portion of the plurality of raised features forms the second image, and the first portion differs from the second portion in one or more of a height, thickness, or angle of the plurality of raised features of the first portion.

14. The method of claim 11, further comprising:
visually identifying the data element on the security feature; and
inputting the code into an input device to match the code with the corresponding code.

15. The method of claim 11, further comprising identifying the data element with a camera device.

16. A security feature for an article, the security feature comprising:
an image element having a first image when the image element is viewed at a first angle and having a second image when the image element is viewed at a second angle, one or more of the first image or the second image comprising a data element for a code that is unique within a set of a plurality of codes.

17. The security feature of claim 16, wherein the image element includes a plurality of raised features arranged in an array upon a substrate.

18. The security feature of claim 17, wherein a first portion of the plurality of raised features forms the first image, and a second portion of the plurality of raised features forms the second image, and the first portion differs from the second portion in one or more of a height, thickness, or angle of the plurality of raised features of the first portion.

19. The security feature of claim 16, wherein the code uniquely identifies the article.

20. The security feature of claim 16, wherein the image element is formed with a printing device.

21. A system for producing a security feature for an article, the system comprising:
a processor configured to generate an image element having a first image when the image element is viewed at a first angle and having a second image when the image element is viewed at a second angle, one or more of the first image or the second image comprising a data element for a code that is unique within a set of a plurality of codes; and
a printing device configured to print the image element.

22. The system of claim 21, wherein the image element is a first image element, and the processor is configured to generate a second image element having a first image when the second image element is viewed at a first angle and having a second image when the second image element is viewed at a second angle, one or more of the first image or the second image of the second image element comprising a data element for a second code that is unique within the set of a plurality of codes.

23. The system of claim 22, wherein the code is a first code, and the first code uniquely identifies a first article and the second code uniquely identifies a second article.

24. The system of claim 21, wherein the printing device is configured to print the image element upon the article.

25. The system of claim 21, wherein the printing device comprises an ink or toner printer.

26. A system for verifying a code on a security feature, the system comprising:
an input device configured to receive an identification of a data element for the code on the security feature for an article, the security feature including an image element having a first image when the image element is viewed at a first angle and having a second image when the image element is viewed at a second angle, one or more of the first image or the second image comprising the data element and the code being unique within a set of a plurality of codes; and
a processor configured to produce a security verification of the code based on a match of the code with a corresponding code in a database.

27. The system of claim 26, wherein the input device comprises one or more camera devices.

28. The system of claim 27, wherein the one or more camera devices includes at least a first camera device and a second camera device, the first camera device configured to visualize the first image and the second camera device configured to visualize the second image.

29. The system of claim 26, wherein the input device comprises a mobile device.

30. The system of claim 29, wherein producing the security verification includes displaying the security verification on a display of the mobile device.
